(19) United States
(12) Patent Application Publication
(10) Pub. No.: US 2013/0080243 A1
(43) Pub. Date: Mar. 28, 2013

(54) PAY PER INSERT SYSTEM

(71) Applicant: Jacqueline R. Dias, Elk Grove Village, IL (US)

(72) Inventor: Jacqueline R. Dias, Elk Grove Village, IL (US)

(21) Appl. No.: 13/240,201

(22) Filed: Sep. 22, 2011

(51) Int. Cl. G06Q 30/02

(52) U.S. Cl. 705/14.43; 705/14.41

(57) ABSTRACT

Method of searching and inserting sales campaigns records into a consumer diary associated with a consumer. The steps include a computer searching a repository for active sales campaign records satisfying search criteria received from a consumer through a browser executing on a device; the computer displaying a list of sales campaign records which satisfies the search criteria; the computer receiving a click indication from the consumer using the browser executing on the device, selecting a sales campaign record from the list; the computer inserting the sales campaign record into the consumer diary; and the computer recording an identification of the consumer from which the click indication originated, a time, and the sales campaign record selected. If the sales campaign record inserted into the consumer diary is not eligible for free inserts into the consumer diary, the computer deducting an amount from a merchant budget coupled to the sales campaign record.

### BACKGROUND OF THE INVENTION

1. Field of the Invention

The invention pertains to the field of marketing. More particularly, the invention pertains to a pay per insert system and method of preventing fraudulent marketing charges to merchants from fraudulent clicks.

2. Description of Related Art

Currently consumers receive sales flyers that are mailed to them by marketing agents paid to represent merchants. The consumers have to organize or file the sales flyers to remind them of various sales events they may want to participate.

Alternatively, a consumer can search the Internet for sales and copy and paste the information about sales events in an electronic format into a document or a personal calendar.

Both of the above conventional methods, namely mailing and searching for sales through the Internet, cannot be automatically updated if the sales event information or sales campaign changes.

If changes occur to the original sales event or sales campaign, the merchant may have to mail or use an electronic message to inform the consumer about the changes. In some cases, the merchant may not be able to track and update if a consumer was interested in a sale and if the consumer marked the sale information in their own calendar. The end result is that information about the sales campaign is fragmented and the consumer may need to piece together information from several locations or sources to take advantage of the sales campaign any updates related to that sales campaign. Additionally, these conventional methods limit the means to find out if consumers received the updated sales campaign. Electronic calendar based actions are not user friendly to both the consumer and the merchant, even though the sales campaigns are time sensitive. Furthermore, vendors providing electronic calendar service use industry acceptable standards or protocols such as iCalendar® they don't seamlessly integrate with each other as is evident in IBM Lotus Notes Reference. In any case, the merchant has no easy means of confirming or reliably updating consumers that receive the original sales campaign.

Most merchants who advertise through the Internet pay for advertising through either a pay per click (PPC) advertising model, where the merchant pays for a click-based event caused by the consumer or a pay per action (PPA) advertising model where the merchant pays for each specified action, such as a purchase and/or a form submission. The PPA model covers only predefined actions, such as sale, completion of registration, download, receipt of subscription and order placement. The action in a PPA advertising model may be “cost per acquisition” (CPA), where the merchant typically pays for a completed sale involving a payment transaction. In “pay per lead” (PPL), such as PPC, the merchant pays only for qualifying leads (a non-cash conversion event, such as a signup involving contact and demographic information).

### SUMMARY OF THE INVENTION

A method of searching and inserting sales campaigns records into a consumer diary associated with a consumer. The steps comprise a computer searching a repository for active sales campaign records satisfying search criteria received from a consumer through a browser executing on a device; the computer displaying a list to the consumer through the browser comprising at least one sales campaign record which satisfies the search criteria; the computer receiving a click indication from the consumer using the browser executing on the device, selecting a sales campaign record from the list; the computer inserting the sales campaign record into the consumer diary associated with the consumer; and the computer recording an identification of the consumer from which the click indication originated, a time, a location and the sales campaign record selected. If the sales campaign record inserted into the consumer diary is not eligible for free inserts into the consumer diary, the computer deducting an amount from a merchant budget coupled to the sales campaign record. If the merchant budget coupled to the sales campaign record is depleted, the computer deactivating the sales campaign record in the repository.

A computer system for searching, inserting, and updating sales campaigns records in a consumer diary. The computer system comprises: at least one processor coupled to at least one computer-readable memory; a sales campaign repository in at least one computer-readable memory, comprising a plurality of sales campaign records for at least one merchant; a merchant diary repository in at least one computer-readable memory, comprising at least one merchant diary with at least one inserted sales campaign record from the sales campaign repository; a consumer diary repository in at least one computer-readable memory, comprising a plurality of consumer diaries, with at least one of the plurality of consumer diaries comprising at least one inserted sales campaign record from the sales campaign repository; a diary manager coupled to the at least one merchant diary in the merchant diary repository and the plurality of consumer diaries in the consumer diary repository for updating the sales campaign records in the consumer diaries and the merchant diaries; and a campaign manager coupled to the diary manager and the sales campaign repository. The campaign manager comprises: a browser interface for searching the sales campaign repository for sales campaign records; a sales campaign record interface for receiving campaign attributes and a budget per insertion of the sales campaign record into the consumer diary from the merchant; a budget monitor for monitoring the budget specified by the merchant for each sales campaign record inserted into the consumer diary; an insert monitor for monitoring which consumers insert which sales campaign records into the consumer diary; and a click and insert reporter for logging and reporting attributes, location and time for each click indication related to a sales campaign selected through the browser interface that resulted in an insertion of the sales campaign record into the consumer diary and which click indications did not result in the insertion of the sale campaign record into the consumer diary.

### BRIEF DESCRIPTION OF THE DRAWING

FIG. 1 shows depicts a pictorial representation of a network of computers in which illustrative embodiments may be implemented.

FIG. 2 shows a conceptual diagram of an embodiment of the present invention.

FIG. 3 shows a flowchart for a method of creating a sales campaign.

FIG. 4 shows a flowchart for a method of updating a sales campaign.

FIGS. 5-6 show flowcharts for a method of searching and subscribing to campaigns and determining if fraudulent clicks have been made.

FIG. 7 shows a conceptual diagram of create and update page for campaign ads of an embodiment of the present invention.

FIG. 8 shows a conceptual diagram of an advanced search page of an embodiment of the present invention.

FIG. 9 shows a conceptual diagram of a user page diary of an embodiment of the present invention.

FIG. 10 shows internal and external components of a client computer and a server computer in which illustrative embodiments may be implemented.

### DETAILED DESCRIPTION OF THE INVENTION

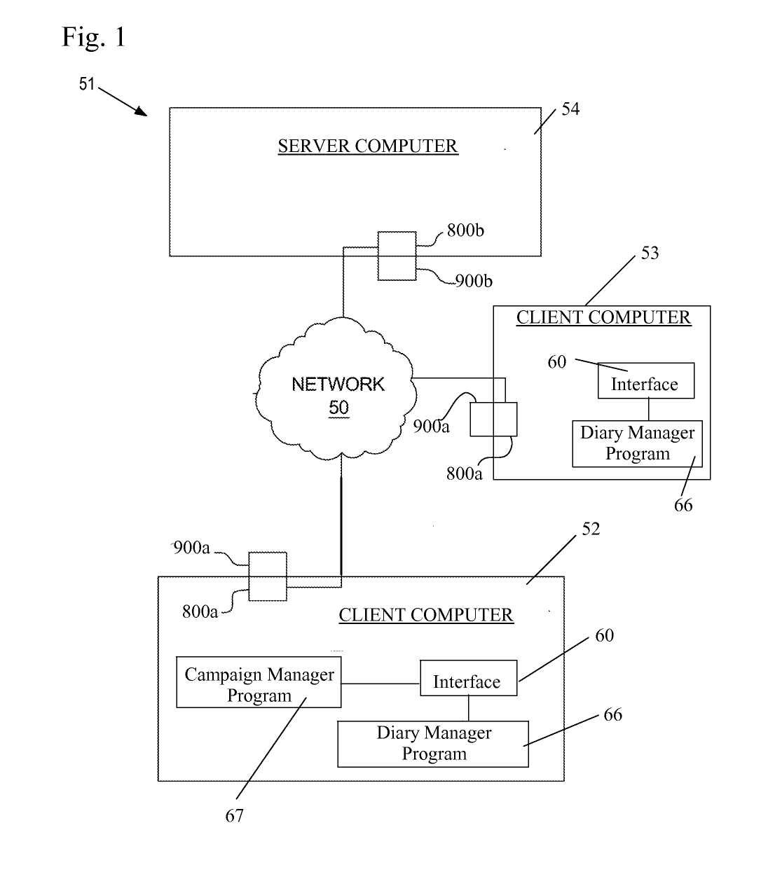

FIG. 1 is an exemplary diagram of a possible data processing environment in which illustrative embodiments may be implemented. It should be appreciated that FIG. 1 is only exemplary and is not intended to assert or imply any limitation with regard to the environments in which different embodiments may be implemented. Many modifications to the depicted environments may be made.

Referring to FIG. 1, network data processing system 51 is a network of computers in which illustrative embodiments may be implemented. Network data processing system 51 contains network 50, which is the medium used to provide communication links between various devices and computers connected together within network data processing system 51. Network 50 may include connections, such as wire, wireless communication links, or fiber optic cables.

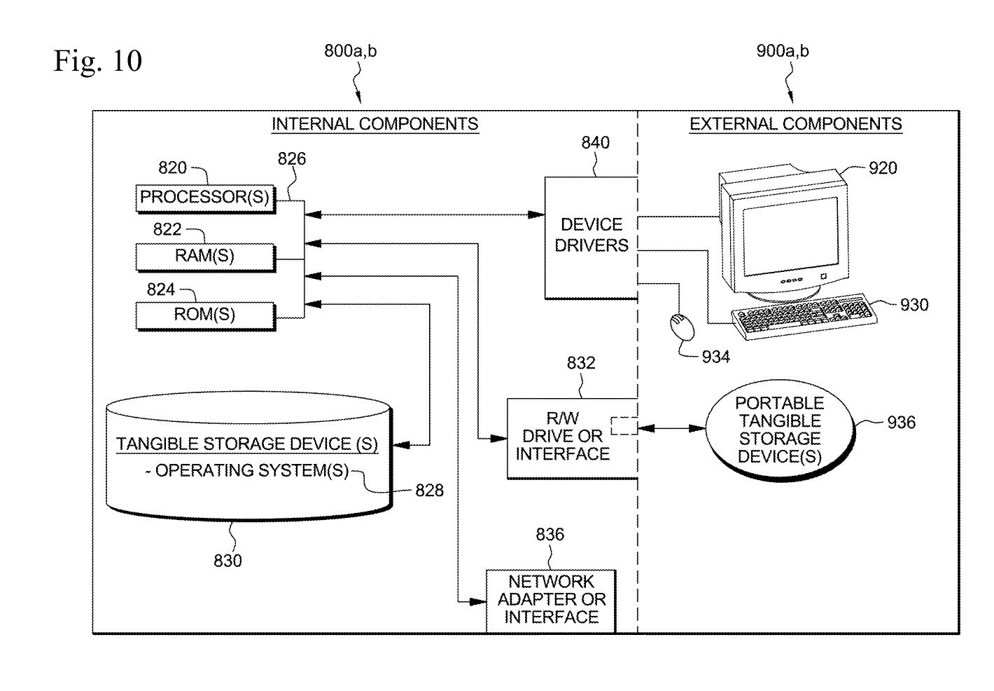

In the depicted example, client computer 52 for merchant use, a client computer for consumer use 53, and server computer 54 connect to network 50. In other exemplary embodiments, network data processing system 51 may include additional client computers, storage devices, server computers, and other devices not shown. Client computers 52, 53 each includes a set of internal components 800a and a set of external components 900a, further illustrated in FIG. 10. Client computers 52, 53 may be, for example, a mobile device, a cell phone, a personal digital assistant, a netbook, a laptop computer, a tablet computer, a desktop computer, or any other type of computing device. Client computers 52, 53 each may contain an interface 60.

Through interface 60, searches of active campaigns may be performed and results of the searches may be displayed to consumer users. Additionally, through interface 60, campaigns may be managed and monitored by merchant users. Interface 60 may accept commands and data entry from users, such as “clicks”. Interface 60 can be, for example, a command line interface, a graphical user interface (GUI), or a web user interface (WUI) through which a user can access a diary manager program 66 and/or a campaign manager program 67 on the client computer 52 or server computer 54 and just the diary manager program 66 on the client computer 53. Server computer 54 includes a set of internal components 800b and a set of external components 900b illustrated in FIG. 10.

It should be noted that the client computer 52 of a merchant has access to both the diary manager program 66 and the campaign manager program 67, but the client computer of the consumer 53 has access to the diary manager only 66 through interface 60.

Program code and programs, such as a diary manager program 66 and a campaign manager program 67, may also be located in network data processing system 51 and may be stored on one or more repositories or computer-readable tangible storage devices 830 shown in FIG. 10, on one or more portable computer-readable tangible storage devices 936 as shown in FIG. 10, or downloaded to a data processing system or other device for use. For example, program code and programs such as a diary manager program 66 or a campaign manager program 67 may be stored on one or more tangible storage devices 830 on server computer 54 and downloaded to client computers 52, 53 over network 50 for use on client computer 52. Alternatively, server computer 54 can be a web server, and the program code and programs such as a diary manager program 66 and a campaign manager program 67 may be stored on at least one of the one or more tangible storage devices 830 on server computer 54 and accessed on client computer 52. A diary manager program 66 and a campaign manager program 67 can be accessed on client computer 52 through interface 60. In other exemplary embodiments, the program code and programs such as a diary manager program 66 and a campaign manager program 67 may be stored on one or more computer-readable tangible storage devices 830 on client computer 52 or distributed between two or more servers.

In the depicted example, network data processing system 51 is the Internet with network 50 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 51 also may be implemented as a number of different types of networks, such as, for example, an intranet, local area network (LAN), or a wide area network (WAN). FIG. 1 is intended as an example, and not as an architectural limitation, for the different illustrative embodiments.

The system described herein utilizes two levels of electronic diaries—consumer diaries and merchant diaries. In a pay per insert (PPI) advertising model, a merchant pays for each time a consumer inserts sales campaign information about one of the merchant's campaigns into their electronic consumer diaries. In addition, merchant electronic diaries provide a means of reliably communicating with the consumers that inserted the sales campaign into their electronic consumer diaries.

Unlike existing PPC models, where consumers can click using any device through the Internet without confirming their identities, in the PPI model, consumers have to confirm their identities by logging into a system before they can click to insert a campaign into their diary. A consumer can generate only one PPI event per campaign, since subsequent attempts to insert the same campaign are ignored, thereby preventing fraudulent charges being levied on the merchant.

The PPI advertising model keeps track of consumers, and tracks inserts into electronic diaries that are performed for the first time for every sale campaign by every consumer. Thus, the system can detect multiple or fraudulent inserts, minimizing incidents where the merchant pays more than once for the same insertion.

The system of the present invention, a PPI advertising model, includes two-fold protection against fraudulent clicks and enables merchants to detect legitimate sources of clicks. First, the consumer is required to confirm their identities by logging into the system, where information regarding the consumer's login session is saved on servers. A white list including a list of IP addresses of servers that have login session information may be used to verify clicks that may seem fraudulent. Second, the system keeps track of the number of inserts into electronic diaries that are performed for every campaign by every consumer. Only one insert per campaign per consumer is allowed. Thus, the system can detect multiple or fraudulent inserts, minimizing incidents where the merchant pays more than once for the same insertion.

In the present application, the term “electronic diary” or “diary” refers to a listing of events where subscribed events are stored on a time or date basis. Events can be updated and can produce reminders to the user for time sensitive campaign data.

The term “white-list” refers to a list of servers or devices which are used to save login session information about consumers and track the number of times a consumer attempts to insert campaign information into their diaries.

The term “campaign” or “sales campaign” refers to one or more advertisements or marketing messages used by merchants to promote their products or services. Typically, a sales campaign will also contain additional promotional information such as discounts, sales information, coupons, and catalogs.

The term “merchant” may refer to a seller of goods and/or services. The term “merchant” also includes advertisers or agents or affiliates working on behalf of the merchant. Such advertisers or agents or affiliates normally provide the consumer with the impression that they are purchasing the goods and/or services directly from the merchant.

The term “consumer” refers to an actual or potential customer who might be interested in events or goods or services provided by a merchant.

The term “click” refers to selecting, using an electronic interface, usually accomplished by pressing a button on a control device such as a mouse, or by touching a designated spot on a touch screen, or an equivalent action.

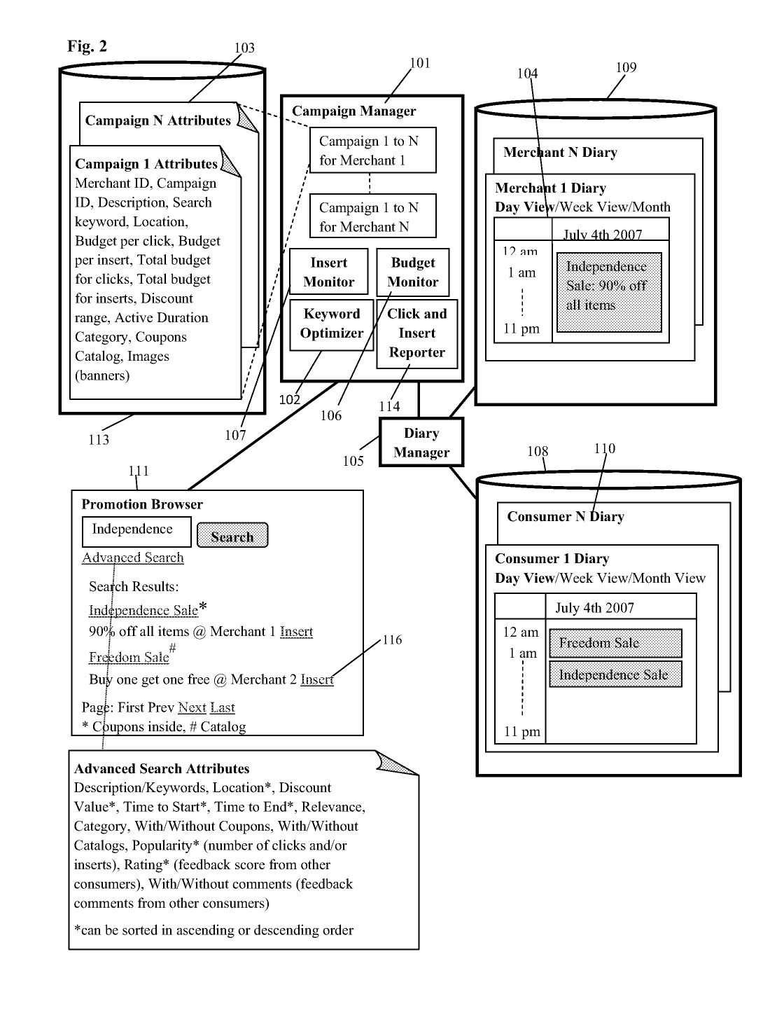

FIG. 2 shows a conceptual diagram of an embodiment of the present invention.

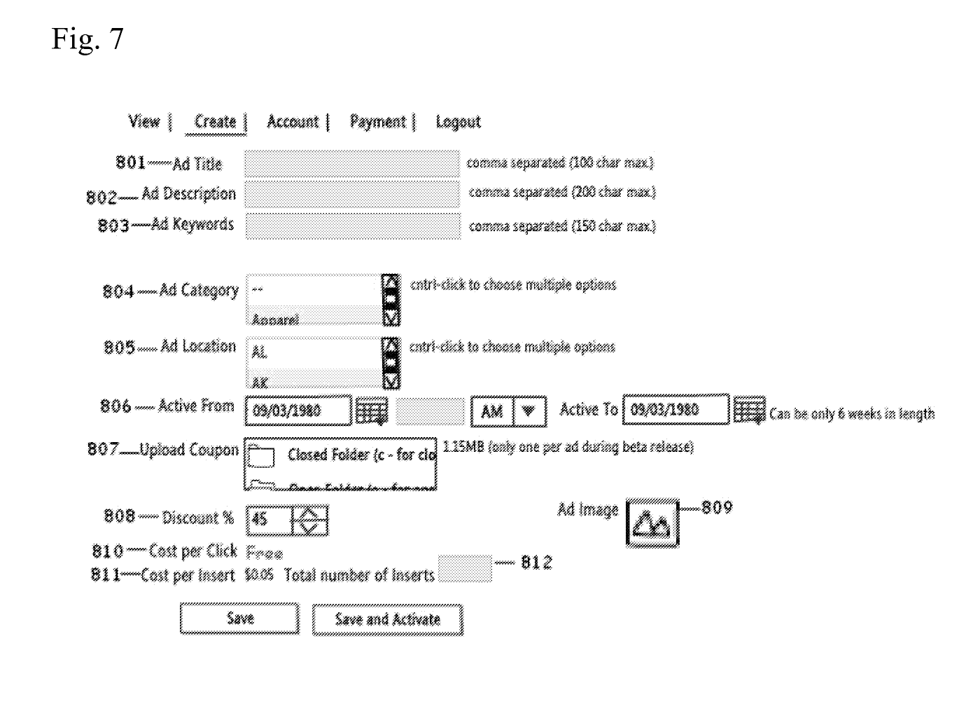

Sales campaign records 103 are managed by a campaign manager 101, preferably through a campaign manager program 68 as shown in FIG. 1. The merchant creates and maintains sales campaign records 103 in a sales campaign repository 113 for each sales campaign a merchant wishes to execute through the system. Sales campaign attributes can be set by the merchant using a sales campaign record interface shown in FIG. 7. Sales campaign records 103 preferably include, but are not limited to, attributes such as merchant ID and campaign ID, which are automatically assigned by the system and other attributes such as title 801, description 802, search keywords 803, location 805, budget “per click” 810, budget “per insert” 811, total budget “per insert” 812, discount % 808, active duration 806, category 804, coupons or catalogs 807, and images 809 which are set by the merchant.

For each sales campaign record 103, the merchant assigns a total amount of money to pay per insertion of the sales campaign by a consumer. The total amount of money per insertion may be a fixed rate or determined by the highest bid. The highest bid is determined by merchants competing with each other to pay a high price for specific search keywords. A merchant that “won” the highest bid or paid a higher price may have only their campaign displayed when specific keywords are searched or have their campaign appear or list before those merchants that paid a lower price.

The total amount of money per insertion may also be capped at a specific threshold based on criteria such as per insert, time interval, or total amount available. Merchants can also use the campaign manager 101 to update current campaign records 103, manage a budget for a specific campaign, alter duration of specific campaigns and activate campaigns.

The campaign manager 101 may include, but is not limited to, subsystems such as a budget monitor 106, an insert monitor 107, a keyword optimizer 102, and a click and insert reporter 114.

The budget monitor 106 keeps track of the amount of money allocated by the merchant for each sales campaign insert into an electronic consumer diary, and the total budget for inserts per campaign. If the total of payments per insert increases to the budget cap set by the merchant, then the sales campaign is deactivated. The merchant is notified and given the option to increase the budget and therefore extend the campaign duration.

The insert monitor 107 tracks which consumers insert which campaigns into their consumer diaries 110.

The keyword optimizer 102 suggests optimized keywords associated with each sales campaign for easy searching by the consumer. These suggestions may be made using synonyms or by determining the traffic and demand for each word in the list of keywords.

The click and insert reporter 114 reports the white-list attributes, location and time for each click related to a campaign through a promotion browser or interface 111. The interface 111 may also be the interface 60 as shown in FIG. 1 The click and insert reporter 114 also tracks and provides statistical and analytical information including, but not limited to which clicks resulted in an insert of a sales campaign into an electronic consumer diary 110 and which clicks did not result in an insert into an electronic consumer diary 110. Merchants may use this statistical and analytical information to improve their sales campaigns and businesses either by discontinuing or improving sales campaigns that did not meet their targets and continuing sales campaigns that met or exceeded their targets.

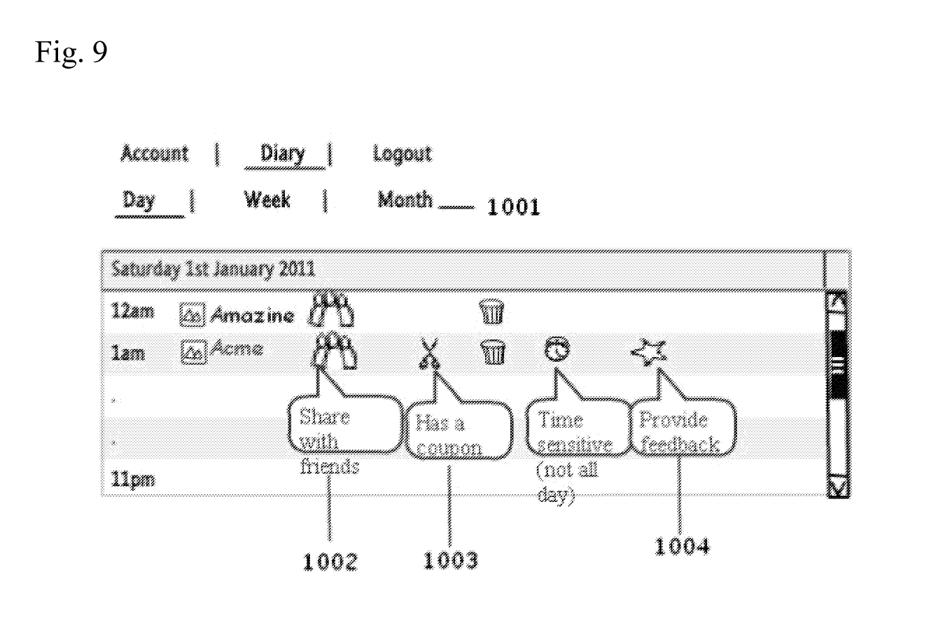

Linked to the campaign manager 101 is a promotion browser 111, providing an interface between the consumer and the campaign manager 101. The promotion browser 111 is used as search tool by consumers to search and find sales campaigns. Only active sales campaigns are displayed to the user through the promotion browser 111. A consumer can conduct an advanced search of the sales campaigns as shown in FIG. 9 based on attributes including but not limited to, description/keywords 901, location 904, discount value 906, time to start 907, time to end 908, category 903, with/without coupons 905, popularity 909 based on the number of clicks and/or inserts, rating based on feedback score from other consumers, and with/without comments based on feedback from other consumers.

The results displayed through promotion browser 111 include an insert option 116 for the consumer to insert the sales campaign 103 into an electronic consumer diary 110. It should be noted that merchant may display sales campaign information such as catalogs and coupons directly on the promotion browser interface 111 or restrict specific details regarding a sales campaign until the consumer inserts the specific sales campaign into a consumer electronic diary 110. The restriction may also be lifted by requiring the consumer or merchant to use paid account upgrades.

A diary manager 105 is in communication with the campaign manager 101 and manages the merchant diaries 104 in merchant diary repository 109 and the electronic consumer diaries 110 in consumer diary repository 108, preferably through a diary manager program 67 as shown in FIG. 1. The two repositories—merchant 109 and consumer 108 could be implemented in the same physical repository, or in separate repositories, as desired.

The diary manager 105 is linked to the campaign manager 101, such that changes to campaign records 103 are coordinated with the appropriate merchant diary 104. The diary manager 105, through the campaign manager 101, may limit the number and types of updates that a merchant can make to the sales campaign record 103. For example, the merchant may only be allowed to make a certain number of updates that include but are not limited to adding more locations and extending the discount period—but not altering the discount itself.

The diary manager 105 may also track whether the consumer has agreed to automatic inserts of sales campaigns for a specific merchant when future campaigns are activated by the merchant and insert said future sales campaigns.

Using known suggestive selling methods, the diary manager 105 may also suggest complementary products and services based on what sales campaigns have already been inserted into their electronic consumer diaries 110. Alternatively, the diary manager 105 may also automatically insert active sales campaigns for similar services and/or products from the same or other merchants within the same category or location. For example, consumers may subscribe to a merchant subscriber group and receive an automatic insert within the electronic consumer diary based on their subscription to the merchant group.

An electronic consumer diary 110 includes a listing of subscribed or inserted sales campaign events as shown in FIG. 10, that may be updated by the merchants through the campaign manager 101 and diary manager 105. Reminders may be generated based on entries in the electronic consumer diary to remind consumers of sales campaign deadlines. Inserted sales campaign events may be listed and viewed by day, week, or month 1001. The inserted sales campaign events may be further sorted based on campaign attributes. Additional actions preferably include, but are not limited to share with friends 1002, view coupons 1003, and provide feedback 1004.

Unlike conventional electronic calendars, the electronic consumer diary 110 does not depend on the creation of invitations or appointments, where the initial list of invitees and their contact addresses need to be known in advance. Here the merchant creates a campaign with open or limited invitation to consumers. The list of invitees grows organically as each consumer subscribes to and/or inserts the campaign information into their electronic consumer diary 110, even if the merchant did not create an initial list of invitees for the sales campaign record 103.

The electronic consumer diary 110 is preferably implemented to allow seamless communication between merchant and consumer.

In an alternate embodiment, the entire sales campaign record 103 or portions of the sales campaign record 103 does not need to be included within the electronic consumer diary 110, instead a link to the sales campaign or event in a merchant diary 104 may be used, thereby eliminating the need to maintain numerous copies of an event across both the merchant diary 104 and the electronic consumer diaries 110. Sales campaign events from the electronic consumer diary 110 may also be shared with a consumer's social network 1002.

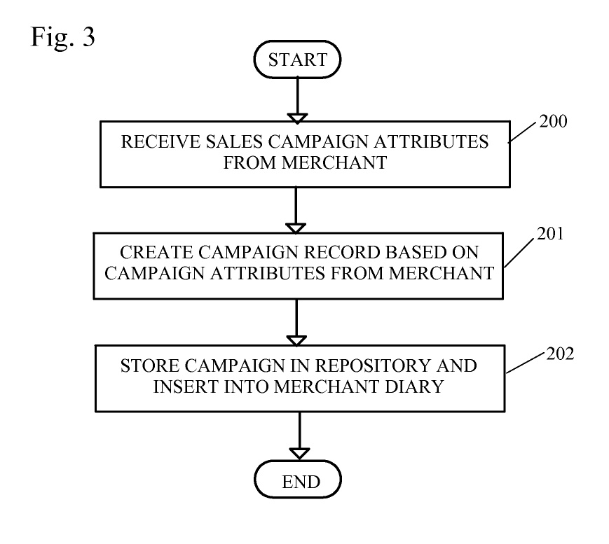

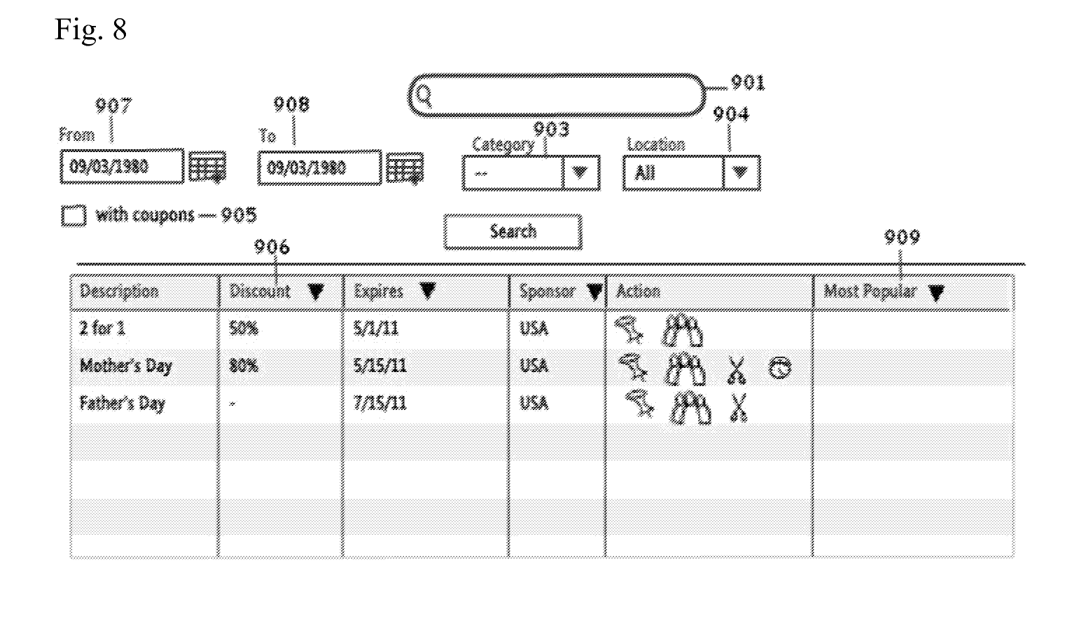

FIG. 3 shows a flowchart of a method for a merchant creating a sales campaign 103. Prior to the start of the flowchart of FIG. 3, a merchant would register and login with the campaign manager 101 and the diary manager 105 and create a merchant diary 104. The campaign manager 101, which may for example be the campaign manager program 68, receives sales campaign attributes 103 and details from the merchant (step 200). The campaign manager 101 creates a sales campaign record 103 in the repository 113 based on the campaign attributes entered by the merchant (step 201). The sales campaign record 103 is stored in repository 113, for example 936, 830 of FIG. 8, and a corresponding diary entry is inserted into a merchant diary 104 (step 202).

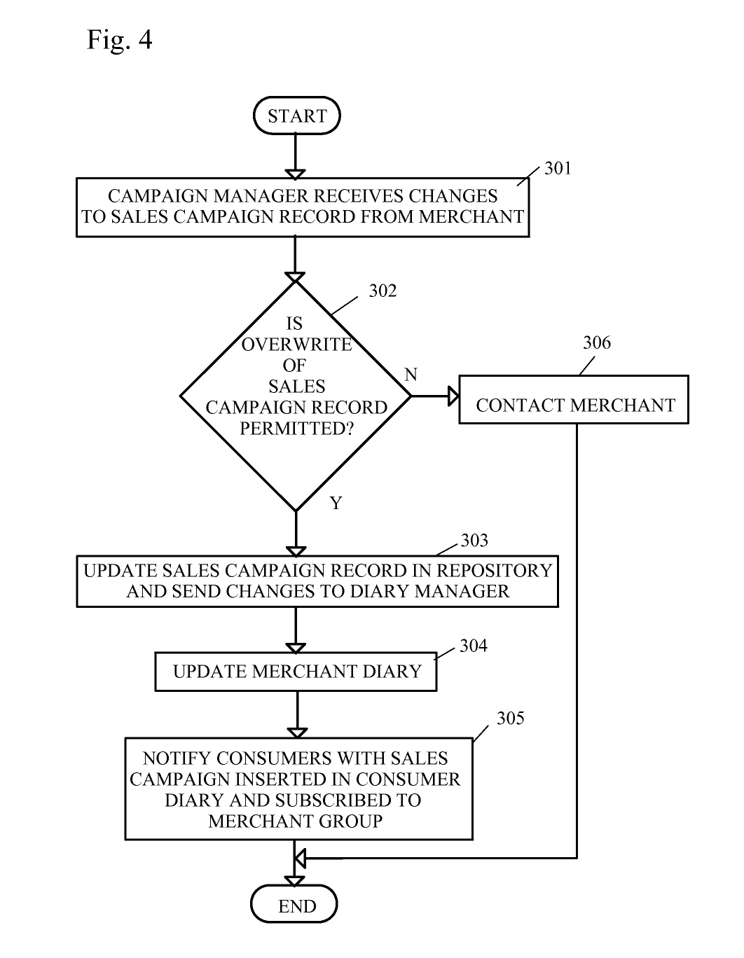

FIG. 4 shows a flowchart of a method of a merchant updating an existing sales campaign record 103 in the repository 113.

The client manager 101, which may for example be the campaign manager program 68, receives changes or an update to an existing sales campaign record 103 from the merchant (step 301).

The method checks to see if an overwrite of the sales campaign record 103 is permitted (step 302), and if it is, the campaign manager 101 updates or overwrites the existing sales campaign record 103 in the repository 113 and sends the changes to the diary manager 105 (step 303). The diary manager 105 updates or overwrites the entry within the merchant diary 104 (step 304), preferably through the diary manager program 66.

The diary manager 105 can notify all consumers with the sales campaign record 103 inserted in their consumer electronic diaries 110 and/or subscribed to the merchant group (step 305), and the method ends.

The consumers' are notified that the sales campaign record 103 was updated and the sales campaign record 103 in their diary 110 is updated automatically or by a consumer action to allow the update of the sales campaign record 103 in the consumer diary 110.

Consumers that don't like the update may choose to delete the sales campaign record 103 from their diaries 110. Such deletions from consumers diaries 110 will not delete the corresponding sales campaign record 103 in the merchant diary 104. Only the merchant that created the sales campaign record 103 can delete the sales campaign record 103. If the merchant were to delete a sales campaign record 103, the diary manager would indicate that the particular deleted sales campaign record 103 as “canceled” in all the consumer electronic diaries 110 in which the record was inserted.

If overwrite of the sales campaign record 103 is not permitted (step 303), the merchant is informed or contacted (step 306) and the method ends.

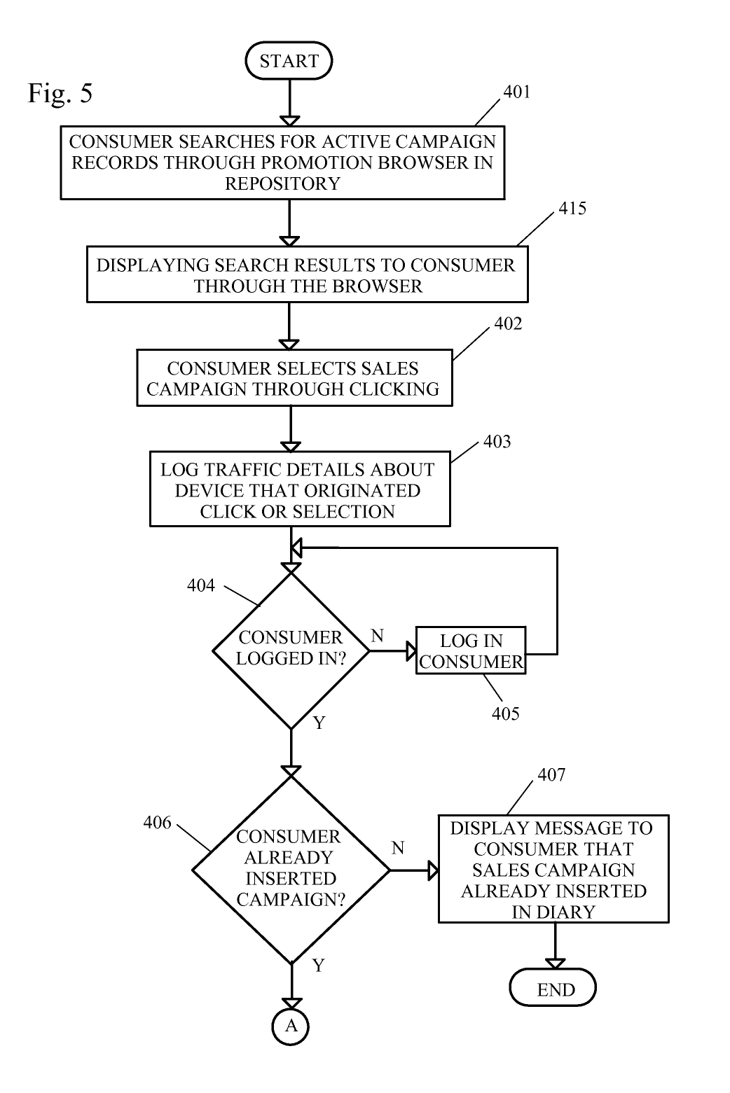

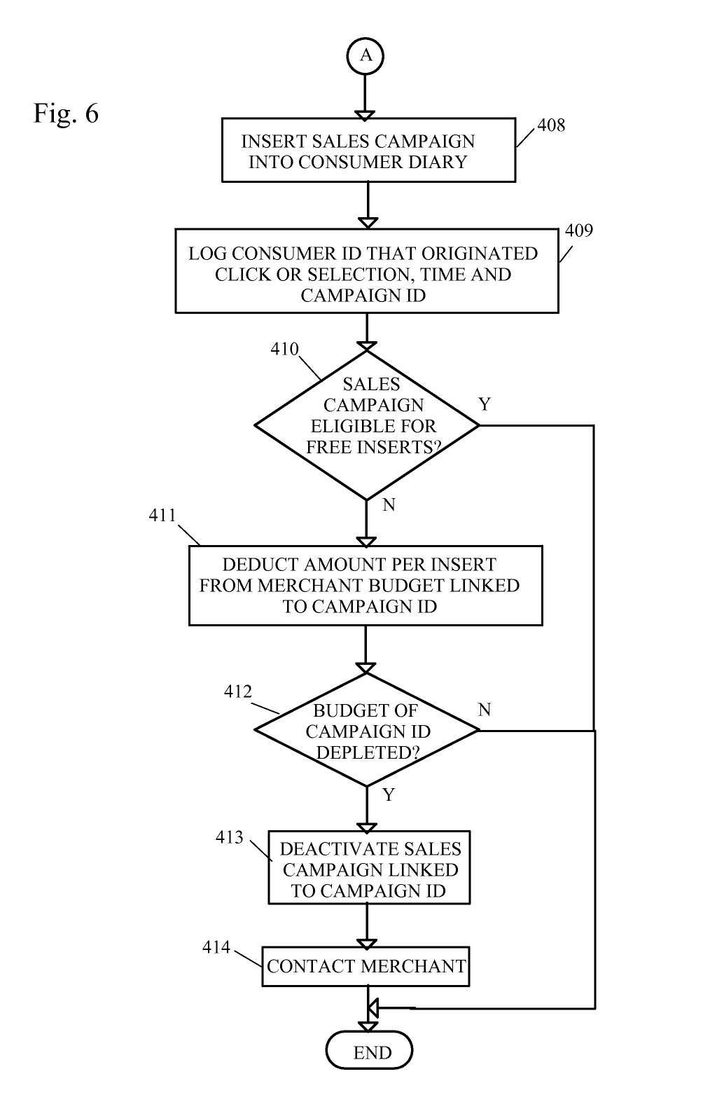

FIGS. 5-6 show a flowchart for a method of searching and subscribing to sales campaigns and determining if fraudulent clicks have been made. Through the promotion browser interface 111, this may for example be interface 60 shown in FIG. 1, a consumer searches for active sales campaign records within the repository 113 (step 401). The promotion browser interface 111 displays a list of active sales campaign records 103 that satisfy the search criteria of the consumer (step 415). The consumer selects a sales campaign record through a “click-based” event or by clicking (step 402). The insert monitor 107 of the campaign manager 101 logs and saves traffic details regarding the device that originated the click or indication (step 403).

If the campaign manager 101 receives an indication that the consumer is not logged in (step 404), display message to consumer to log in consumer (step 405), and return to step 404 of whether the consumer is logged in.

If the campaign manager 101 receives an indication that the consumer is logged in (step 404) and the consumer has already inserted the sales campaign record into their electronic consumer diary 110 (step 406), display message indicating that the sales campaign record is already present within their electronic consumer diary 110 (step 407) and the method ends.

If the campaign manager 101 receives an indication that the consumer has not already inserted the sales campaign record into their electronic consumer diary 110 (step 406), insert the sales campaign record into the electronic consumer diary (step 408).

The step of insertion of the sales campaign record into the electronic consumer diary (step 408) may use information from logs generated during inserts of sales campaign record 103 inserts (step 409) to trigger additional events including, but not limited to incrementing a popularity counter that displays the number of people that prefer the merchant's campaign, the number of people that are participating in the merchant's campaign, incrementing counters that display the time within which a number of people sign up for a merchant's sales campaign and the number of people are fans of the merchant. Information ascertained from logs generated during step 409 may be displayed in a variety of locations including, but not limited to popularity 909, merchant's business site and third party sites as shown in FIG. 8.

The insert monitor 107 or the click and insert reporter 114 of the campaign manager logs information including, but not limited to the consumer ID that originated the click or selection, the time, location and the campaign ID (step 409).

If the sales campaign record inserted into a consumer's electronic diary 110 is eligible for free insertions (step 410) the method ends and the merchant is not charged.

If the sales campaign record is not eligible for free insertions (step 410), deduct amount per insert from merchant budget for the sales campaign (step 411).

If the budget of the sales campaign record associated with the campaign ID is not depleted or exhausted (step 412), the method ends.

If the budget of the sales campaign record associated with the campaign ID is depleted or exhausted (step 412), deactivate the sales campaign record linked to the campaign ID to prevent further insertions (step 413) and contact the merchant in regards to the budget of the sales campaign record associated with the campaign ID (step 414) and the method ends.

FIG. 10 illustrates internal and external components of client computers 52, 53 and server computer 54 in which illustrative embodiments may be implemented. In FIG. 10, client computers 52, 53 and server computer 54 include respective sets of internal components 800a, 800b, and external components 900a, 900b. Each of the sets of internal components 800a, 800b includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828 and a diary manager program 66 and a campaign manager program 67 are stored on one or more of the computer-readable tangible storage devices 830 for execution by one or more of the processors 820 via one or more of the RAMs 822 (which typically include cache memory). In the embodiment illustrated in FIG. 10, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800a, 800b also includes a R/W drive or interface 832 to read from and write to one or more portable computer-readable tangible storage devices 936 such as a CD-ROM, DVD, memory stick, magnetic tape, magnetic disk, optical disk or semiconductor storage device. A diary manager program 66 and a campaign manager program 67 can be stored on one or more of the portable computer-readable tangible storage devices 936, read via R/W drive or interface 832 and loaded into hard drive 830.

Each set of internal components 800a, 800b also includes a network adapter or interface 836 such as a TCP/IP adapter card. A diary manager program 66 and a campaign manager program 67 can be downloaded to computer 52 and server computer 54 from an external computer via a network (for example, the Internet, a local area network or other, wide area network) and network adapter or interface 836. The diary manager program 67 can be downloaded to computer 53 from an external computer via a network (for example, the Internet, a local area network or other, wide area network) and network adapter or interface 836. From the network adapter or interface 836, a diary manager program 66 and a campaign manager program 67 are loaded into hard drive 830. The network may comprise copper wires, optical fibers, wireless transmission, routers, firewalls, switches, gateway computers and/or edge servers.

Each of the sets of external components 900a, 900b includes a computer display monitor 920, a keyboard 930, and a computer mouse 940. Each of the sets of internal components 800a, 800b also includes device drivers 840 to interface to computer display monitor 920, keyboard 930 and computer mouse 940. The device drivers 840, R/W drive or interface 832 and network adapter or interface 836 comprise hardware and software (stored in storage device 830 and/or ROM 824).

A diary manager program 66 and a campaign manager program 67 can be written in various programming languages including low-level, high-level, object-oriented or non object-oriented languages. Alternatively, the functions of a diary manager program 66 and a campaign manager program 67 can be implemented in whole or in part by computer circuits and other hardware (not shown).

Based on the foregoing, a computer system, method and program product have been disclosed for inserting sales campaigns into electronic consumer diaries and preventing fraudulent charges to merchants. However, numerous modifications and substitutions can be made without deviating from the scope of the present invention. Therefore, the present invention has been disclosed by way of example and not limitation.

What is claimed is:

1. A method of searching and inserting sales campaigns records into a consumer diary associated with a consumer, the method comprising the steps of:
a computer searching a repository for active sales campaign records satisfying search criteria received from a consumer through a browser executing on a device;
the computer displaying a list to the consumer through the browser comprising at least one sales campaign record which satisfies the search criteria;
the computer receiving a click indication from the consumer using the browser executing on the device, selecting a sales campaign record from the list;
the computer inserting the sales campaign record into the consumer diary associated with the consumer; and
the computer recording an identification of the consumer from which the click indication originated, a time, a location and the sales campaign record selected;
if the sales campaign record inserted into the consumer diary is not eligible for free inserts into the consumer diary, the computer deducting an amount from a merchant budget coupled to the sales campaign record;
if the merchant budget coupled to the sales campaign record is depleted, the computer deactivating the sales campaign record in the repository.

2. The method of claim 1, wherein the method further comprises, before the step of inserting the sales campaign record into the consumer diary, preventing entry of duplicate sales campaign records by the steps of:
the computer checking the consumer diary to see if the sales campaign record has already been inserted into the consumer diary;
if the consumer has already inserted the sales campaign record into the consumer diary, displaying an indication to the consumer that the sales campaign record has already been inserted into the consumer diary; and
ending the method without entering the sales campaign record into the consumer diary.

3. The method of claim 1, wherein the sales campaign record is created by the steps comprising:
the computer receiving sales campaign attributes from a merchant;
the computer creating a sales campaign record based on the campaign attributes from the merchant; and
the computer storing the sales campaign record in the repository and in a merchant diary.

4. The method of claim 3, further comprising the step, when a sales campaign record is created, automatically inserting the sales campaign record into the consumer diary associated with a consumer who has agreed to automatic inserts of sales campaigns from the merchant.

5. The method of claim 3, performed by using browser interfaces comprising web pages and electronic forms.

6. The method of claim 1, further comprising the computer recording details about the device in a server.

7. The method of claim 1, further comprising updating a sales campaign record in the repository, comprising the steps of:
the computer receiving changes to a sales campaign record from a merchant;
if overwriting of a sales campaign record is permitted in the repository, then
the computer updating the sales campaign record in the repository;
the computer sending changes to the sales campaign record to a diary manager;
the diary manager updating the merchant diary; and
the diary manager notifying consumers with the sales campaign record inserted into their consumer diary of the change to the sales campaign record.

8. The method of claim 7, further comprising sending a notification of the change to the sales campaign record to consumers subscribed to a group associated with the merchant.

9. The method of claim 7, further comprising the diary manager updating the consumer diaries of all of the consumers with the sales campaign record inserted to reflect the changes to the sales campaign record.

10. The method of claim 1, further comprising deleting the sales campaign record from the merchant diary and notifying consumers that the sales campaign record has been cancelled by the merchant.

11. The method of claim 1, further comprising incrementing a popularity counter that displays a number of people that prefer the merchant's campaign or the merchant from the step of the computer recording an identification of the consumer from which the click indication originated, a time, and the sales campaign record selected.

12. The method of claim 1, further comprising incrementing a popularity counter that displays a time in within which a number of people participating in the insertion of the sales campaign record into their consumer diaries from the step of the computer recording an identification of the consumer from which the click indication originated, a time, and the sales campaign record selected.

13. The method of claim 1, performed by using multiple browser interfaces comprising web pages and electronic forms.

14. A computer system for searching, inserting, and updating sales campaigns records in a consumer diary, the computer system comprising:
at least one processor coupled to at least one computer-readable memory;
a sales campaign repository in at least one computer-readable memory, comprising a plurality of sales campaign records for at least one merchant;
a merchant diary repository in at least one computer-readable memory, comprising at least one merchant diary with at least one inserted sales campaign record from the sales campaign repository;
a consumer diary repository in at least one computer-readable memory, comprising a plurality of consumer diaries, with at least one of the plurality of consumer diaries comprising at least one inserted sales campaign record from the sales campaign repository;
a diary manager coupled to the at least one merchant diary in the merchant diary repository and the plurality of consumer diaries in the consumer diary repository for updating the sales campaign records in the consumer diaries and the merchant diaries; and
a campaign manager coupled to the diary manager and the sales campaign repository comprising:
a browser interface for searching the sales campaign repository for sales campaign records;
a sales campaign record interface for receiving campaign attributes and a budget per insertion of the sales campaign record into the consumer diary from the merchant; and
a budget monitor for monitoring the budget specified by the merchant for each sales campaign record inserted into the consumer diary.

15. The system of claim 14, further comprising a keyword optimizer for suggesting optimized keywords associated with each sales campaign record.

16. The system of claim 14, wherein the sales campaign record comprises a merchant ID, a campaign ID, sale attributes describing a sale from the merchant, and budget attributes.

17. The system of claim 16, wherein the sale attributes comprise at least one of a title, a description, searchable keywords, a location, a discount percent, an active duration, a category, coupons or catalogs, and images.

18. The system of claim 16, wherein the budget attributes are selected from a group comprising budget “per click”, budget “per insert”, and total budget “per insert”.

19. The system of claim 14, wherein the sales campaign record inserted into the consumer diary is a link to the sales campaign record in the merchant diary.

20. A computer system for logging, reporting, and analyzing insert information associated with sales campaign records, the computer system comprising:
at least one processor coupled to at least one computer-readable memory;
a sales campaign repository in at least one computer-readable memory, comprising a plurality of sales campaign records for at least one merchant;
a consumer diary repository in at least one computer-readable memory, comprising a plurality of consumer diaries, with at least one of the plurality of consumer diaries comprising at least one inserted sales campaign record from the sales campaign repository;
an insert monitor for monitoring which consumers insert sales campaign records into the consumer diary and delete sales campaign records from the consumer diary;
a click and insert reporter for logging and reporting attributes, location, and time for each click indication related to a sales campaign selected through a browser interface that resulted in an insertion of the sales campaign record into the consumer diary, deletion of a sales campaign record from the consumer diary and which click indications did not result in the insertion of the sale campaign record into the consumer diary, the click and insert reporter also statistically and analytically processing the logs of attributes, location, and time.
